(19) United States
(12) Patent Application Publication
(10) Pub. No.: US 2008/0296811 A1
(43) Pub. Date: Dec. 4, 2008

(54) METHOD FOR PRODUCING DUCT

(75) Inventors: Seiji Tachibana, Toyoake-city (JP); Toshiaki Nakayama, Nishikamo-gun (JP); Yoshitaka Nishio, Nagoya-city (JP); Naohito Seko, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya City (JP)

(21) Appl. No.: 12/130,580

(22) Filed: May 30, 2008

(30) Foreign Application Priority Data
Jun. 1, 2007 (JP) 2007-146625
Dec. 20, 2007 (JP) 2007-328585

(51) Int. Cl. B29C 49/08

(52) U.S. Cl. 264/535

(57) ABSTRACT

According to a method for producing a duct, a cylindrical preform, which opens at its both end portions in a longitudinal direction and has a central part, is formed. The central part is narrowed with respect to the both end portions. The central part has a smaller cross-sectional area than that of the both end portion. The preform is formed from a thermoplastic material, which increases in strength when stretched. Next, the preform is heated. Then, stretch blow molding is performed on the preform by stretching the preform in axial and radial directions thereof, such that the cross-sectional area of the central part becomes generally the same as that of the both end portion, or equal to or larger than that of the both end portion. The central part is narrowed to such an extent that it retains predetermined strength after performing the molding on the preform.

### CROSS REFERENCE TO RELATED APPLICATION

This application is based on and incorporates herein by reference Japanese Patent Application No. 2007-146625 filed on Jun. 1, 2007 and Japanese Patent Application No. 2007-328585 filed on Dec. 20, 2007.

### BACKGROUND OF THE INVENTION

1. Field of the Invention

The present invention relates to a method for producing a duct in which fluid such as air flows.

2. Description of Related Art

In recent years, a reduction in noises has been increasingly required of an automobile, and a suction noise caused by an engine suction pulse is also one of the noises that need to be reduced. As a technology for reducing the above suction noise, the present applicant has proposed a noise reduction duct attached to an air intake duct of the engine (see Japanese Patent Application No. 2007-119651). The above noise reduction duct has a body portion for reducing a noise and a fastening portion (both end portions), to which a hose is attached. The body portion is made of a thin film, and the fastening portion is made of a thick wall. A conventional duct is generally manufactured by direct blow molding The direct blow molding is a method, whereby a cylindrical parison made from thermoplastics is put between a pair of molds, and pressurized air is blown thereinto so as to swell the parison.

However, since thickness of its body portion is as thin as 0.5 mm or less, the above noise reduction duct is difficult to produce by the direct blow molding. More specifically, in the case of the direct blow molding, although it is possible to vary wall thickness of mold goods by widely known parison control, it is difficult to actually form a thin film of 0.5 mm or less because a shape of a parison becomes difficult to maintain when a wall thickness of the parison is adjusted such that the wall thickness of mold goods is 0.5 mm or less. Furthermore, in the direct blow molding, since a closed-end part is formed in mold-clamping the parison, the closed-end part, which is unnecessary for a duct, needs to be cut off in a post process. As a result, scrap materials are generated, and product cost is increased because of the cost of equipment needed in the post process. Accordingly, as disclosed in Japanese Unexamined Patent Application Publication No. 05-154896, a method of manufacturing a cylindrical object such as a pipe, by stretching a cylindrical parison (preform) extending in an axial center direction and supplying air to the inside of the parison to swell its hollow peripheral wall part, is publicly known.

However, according to the known art disclosed in the above Publication No. 05-154896, a diameter of a central part of the parison is decreased only by a draft of the mold with respect to diameters of openings of both ends of the parison having a pipe shape before the stretch blow molding. When a material whose strength is obtained by extending it, such as PET (polyethylene terephthalate) or PEN (polyethylenenaphthalate), is used, the above material is hardly extended in a radial direction despite the blow molding, and thus, its strength cannot be obtained. Thus, when a cylindrical object such as a duct is manufactured by the stretch blow molding, a cross-sectional area of openings of both ends of the object being generally the same as a cross-sectional area of its central part (body portion), or a body portion of the object having a larger cross-sectional area than openings of its both ends, despite the use of a material such as PET or PEN, its strength cannot be increased by the known art, which is disclosed in the above Publication No. 05-154896.

### SUMMARY OF THE INVENTION

The present invention addresses the above disadvantages. Thus, it is an objective of the present invention to provide a method for producing a duct, a wall thickness of which is small and which has high strength. Each of openings at both ends of the duct and a body portion of the duct have generally the same cross-sectional areas, or the body portion has a larger cross-sectional area than each of the openings at both ends.

To achieve the objective of the present invention, there is provided a method for producing a duct. According to the method, a cylindrical preform, which opens at both end portions of the preform in a longitudinal direction of the preform and has a central part, is formed. The central part is narrowed with respect to the both end portions. The central part has a smaller cross-sectional area than a cross-sectional area of each of the both end portions. The preform is formed from a thermoplastic material, which increases in strength when stretched. The preform is heated after the forming of the preform. Stretch blow molding is performed on the preform after the heating of the preform by stretching the preform in an axial direction as well as in a radial direction of the preform, such that the cross-sectional area of the central part becomes one of: generally the same as the cross-sectional area of each of the both end portions; and equal to or larger than the cross-sectional area of each of the both end portions. The central part of the preform is narrowed to such an extent that the central part retains predetermined strength after the performing of the stretch blow molding on the preform.

### BRIEF DESCRIPTION OF THE DRAWINGS

The invention, together with additional objectives, features and advantages thereof, will be best understood from the following description, the appended claims and the accompanying drawings in which:

FIG. 1A is a longitudinal sectional view illustrating an inner duct used for a silencer according to a first embodiment of the invention;

FIG. 1B is a cross-sectional view taken along a line IB-IB in FIG. 1A;

FIG. 2A is a longitudinal sectional view illustrating the silencer according to the first embodiment;

FIG. 2B is a cross-sectional view taken along a line IIB-IIB in FIG. 2A;

FIG. 3A is a longitudinal sectional view illustrating a preform according to the first embodiment;

FIG. 3B is a cross-sectional view illustrating a central part of the preform taken along a line IIIB-IIIB in FIG. 3A;

FIG. 3C is a cross-sectional view illustrating a major diameter portion of the preform taken along a line IIIC-IIIC in FIG. 3A;

FIG. 4 is a diagram illustrating a heating process according to the first embodiment;

FIG. 5A is a diagram illustrating a stretching process before stretching the preform according to the first embodiment;

FIG. 5B is a diagram illustrating the stretching process after stretching the preform according to the first embodiment;

FIG. 6A is a diagram illustrating a blow molding process before high-pressure gas is blown to an inside of the preform according to the first embodiment;

FIG. 6B is a diagram illustrating the blow molding process after the high-pressure gas is blown to the inside of the preform according to the first embodiment;

FIG. 7A is a longitudinal sectional view illustrating an inner duct used for a silencer according to a second embodiment of the invention;

FIG. 7B is a cross-sectional view illustrating a body portion of the inner duct taken along a line VIIB-VIIB in FIG. 7A; and

FIG. 7C is a cross-sectional view illustrating a duct end portion of the inner duct taken along a line VIIC-VIIC in FIG. 7A.

### DETAILED DESCRIPTION OF THE INVENTION

Embodiments of the invention are described in detail below with reference to drawings.

### First Embodiment

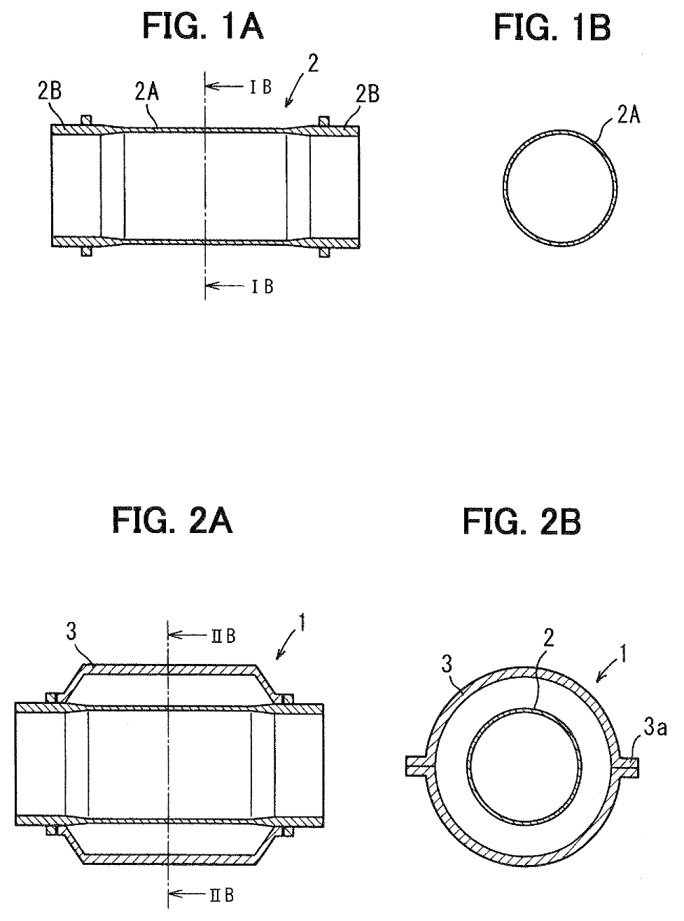

A silencer 1 of a first embodiment of the invention reduces a suction noise of an internal combustion engine, for example, and as shown in FIG. 2A, includes an inner duct 2, which defines a part of a suction passage of the engine, and an outer ducts 3, which is arranged around the inner duct 2 via an air layer. The inner duct 2 includes a body portion 2A, a cross section of which perpendicular to a flow direction of air has a round shape as shown in FIG. 1B, and a duct end portion 2B, which has an opening at both ends of the body portion 2A in a longitudinal direction thereof as shown in FIG. 1A. A cross-sectional area of the body portion 2A is generally the same as a cross-sectional area of the duct end portion 2B.

The body portion 2A has a thickness of 0.5 mm or less, preferably 0.2 mm. The duct end portion 2B is formed, for example, as a fastening portion for connecting a hose or the like to the inner duct 2, and has a wall thickness that is larger (e.g., 2 mm) than that of the body portion 2A. More specifically, the central part 20b, which is constricted in the phase in which the preform 20 is molded, is extended in its longitudinal direction in the stretch blow process and swollen in its radial direction so as to form the body portion 2A of the duct 2. The wall thickness of the body portion 2A is smaller than the wall thickness of each of the both ends 2B of the duct 2 in the longitudinal direction of the duct 2. Since the wall thickness of the both ends 2B is made larger than that of the body portion 2A, the strength of the both ends 2B serving as a fastening portion is ensured when a hose or the like is connected to the duct 2. Furthermore, by making the wall thickness of the body portion 2A small, weight saving of the duct 2 is achieved. One duct end portion 2B is connected to, for example, an outlet of an air cleaner (not shown), and the other duct end portion 2B is connected to, for example, an inlet of a throttle body (not shown). The inner duct 2 is manufactured by stretch blow molding, which is described in greater detail hereinafter, As shown in FIG. 2B, the outer duct 3 is formed by combining a pair of half ducts, each of which has a semicircular arc cross-sectional shape, and is fixed by coupling flanged portions 3a of both the half ducts together with the duct end portion 2B of the inner duct 2 placed between the pair of half ducts.

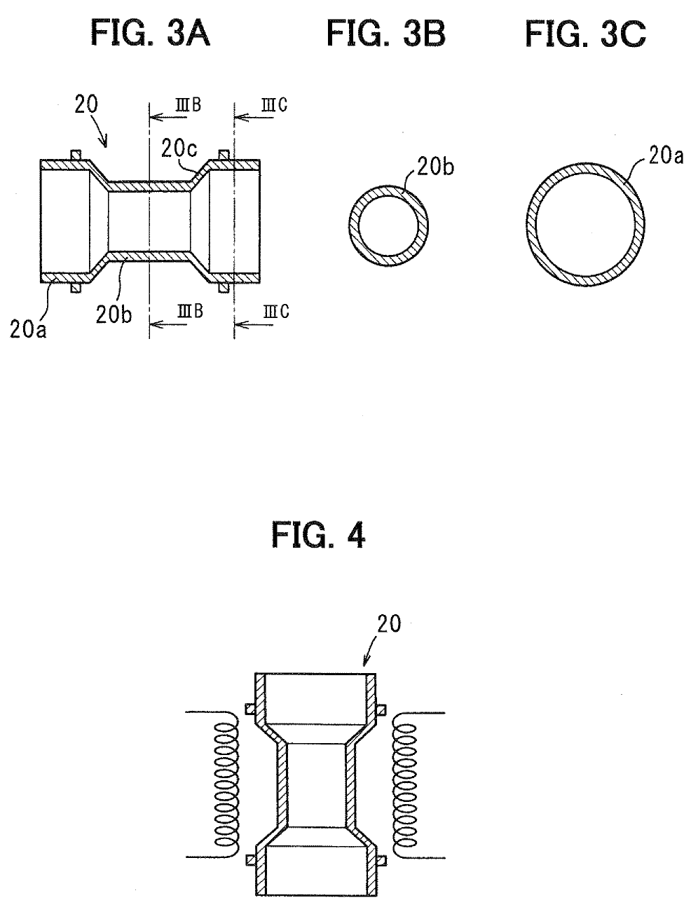

A production method of the inner duct 2 according to the invention is explained with reference to FIGS. 3A to 6B.

### (a) Preform Forming Process

Melted thermoplastics is injected into a metal mold to form a preform 20 in a widely known injection molding process, for example. As shown in FIG. 3A, the preform 20 includes a major diameter portion 20a, which is formed into the duct end portion 2B after molding, a central part 20b, which has a smaller cross-sectional area than the major diameter portion 20a, and a tapered portion 20c, which connects the major diameter portions 20a and the central part 20b. As shown in FIGS. 3B, 3C, the central part 20b and the major diameter portion 20a have a circular cross-sectional shape, and a cross-sectional area of the central part 20b is smaller than the major diameter portion 20a. In other words, the preform 20 is formed in a cylindrical drum-shape, in which the central part 20b is narrower than the major diameter portion 20a via the tapered portion 20c. A material, strength of which increases by stretching it, such as PET (polyethylene terephthalate) or PEN (polyethylenenaphthalate), is used as the thermoplastics.

### (b) Heating Process

As shown in FIG. 4, the molded preform 20 is heated to appropriate temperature.

### (c) Stretching Process

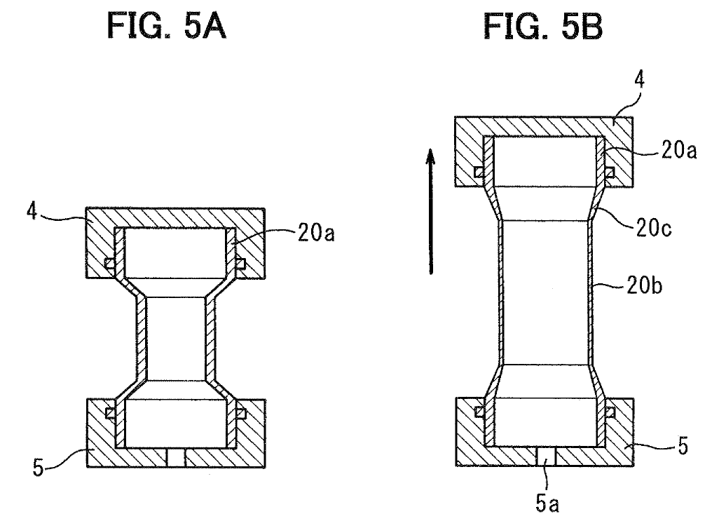

As shown in FIGS. 5A, 5B, the preform 20 is stretched in its longitudinal direction (vertical direction in FIG. 5B) with both the major diameter portions 20a of the preform 20 held by an upper die 4 and a lower die 5. Meanwhile, for example, by pulling up the upper die 4 to an upper side (in an arrow direction) of FIG. 5B with the lower major diameter portion 20a of the preform 20 fixed in the lower die 5 so as to pull the upper major diameter portion 20a of the preform 20, the central part 20b and the tapered portion 20c are extended in the longitudinal direction to have a thin wall. In holding the major diameter portions 20a of the preform 20, the upper die 4 and the lower die 5 airtightly respectively close opening surfaces of the major diameter portions 20a.

### (d) Blow Molding Process

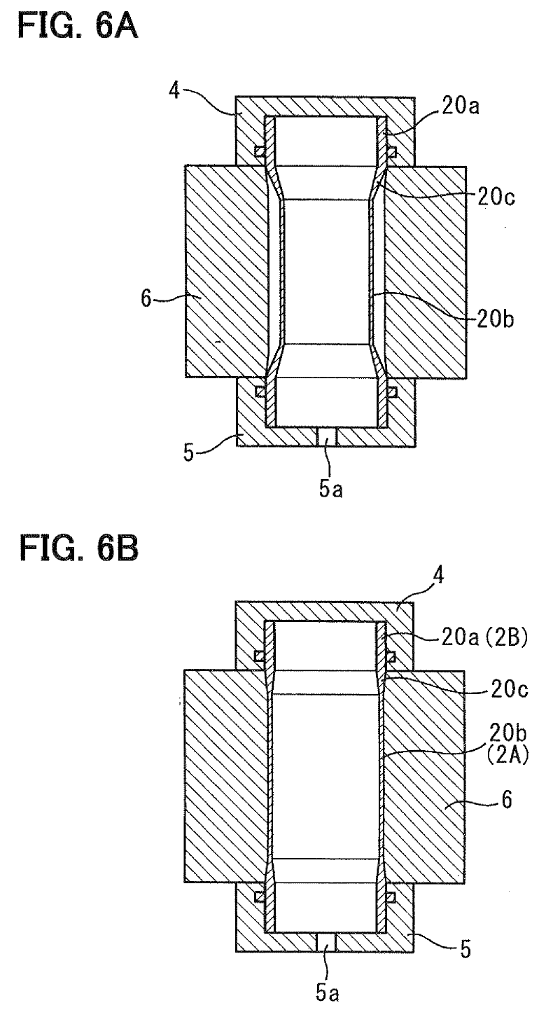

As shown in FIG. 6A, after a coupling mold 6 for blow-molding is put between the upper die 4 and the lower die 5 be arranged on an outer circumference of the tapered portion 20c and the central part 20b, high pressure gas is blown to the inside of a preform 20, for example, through a blow hole 5a formed in the lower die 5. Accordingly, as shown in FIG. 6B, the tapered portion 20c and the central part 20b are radially stretched until the tapered portion 20c and the central part 20b are closely-attached on an inner circumferential surface of the coupling mold 6. As a result, the body portion 2A of the inner duct 2 is formed.

### (Advantageous Effects of the First Embodiment)

By the production method of the duct according to the first embodiment, the inner duct 2 having high strength is manufactured by use of the thermoplastics (PET, PEN) whose strength is increased by stretching them. By performing the stretch blow molding on the drum-shaped preform 20, in which the central part 20b is narrower with respect to the major diameter portion 20a in axial and radial directions of the preform 20, until the cross-sectional area of the central part 20b becomes generally the same as the cross-sectional area of the major diameter portion 20a, an elongation percentage in the radial direction is made large. Accordingly, the body portion 2A having high strength is formed.

In addition, (thermoplastics whose) “strength is increased by stretching them” means that: in the case of producing two ducts whose materials are the same and whose wall thicknesses are the same, when a duct produced by a method, which does not include the stretch blow process, is compared with a duct of the invention, that is, the duct produced by a method, which includes the stretch blow process, the duct of the invention has higher strength than the former duct.

Since the inner duct 2 of the first embodiment is manufactured by the stretch blow molding, the wall thickness of the body portion 2A is made as thin as 0.5 mm or less. More specifically, by extending the preform 20 in its longitudinal direction in the stretching process shown in FIGS. 5A, 5B, the wall thickness of the central part 20b (part eventually formed into the body portion 2A) is made thin, and thus the wall thickness of the preform 20 does not need to be small more than needed in the phase of molding the preform 20. As a result, the inner duct 2 having the body portion 2A, which has a thickness of 0.5 mm or less and is thus difficult to form by conventional direct blow molding, is produced. The central part 20b of the preform 20 may be narrowed to such an extent that the central part 20b retains predetermined strength after the performing of the stretch blow molding on the preform 20. In other words, the central part 20b of the preform 20 is constricted to such an extent that a material, which increases in strength when stretched, is stretched in a predetermined stretch ratio.

Because outer circumferential surfaces of the major diameter portions 20a of the preform 20 are held in the upper die 4 and the lower die 5, respectively in performing the blow molding on the preform 20, the major diameter portion 20a does not swell radially outward when high pressure gas is blown into the inside of the preform 20. In other words, Since the wall thickness of the major diameter portion 20a does not become thin by the blow molding, and is made larger than the body portion 2A, which is formed by extending the central part 20b in the radial direction as well as axial direction, strength of the duct end portion 2B formed as a fastening portion is ensured. According to the above production method, the stretch blow molding is performed on the drum-shaped preform 20 having their both ends, which are open, and thus a closed-end part is not produced in mold goods. As a result, post processing is unnecessary for cutting off the closed-end part, so that scrap materials are not generated.

### Second Embodiment

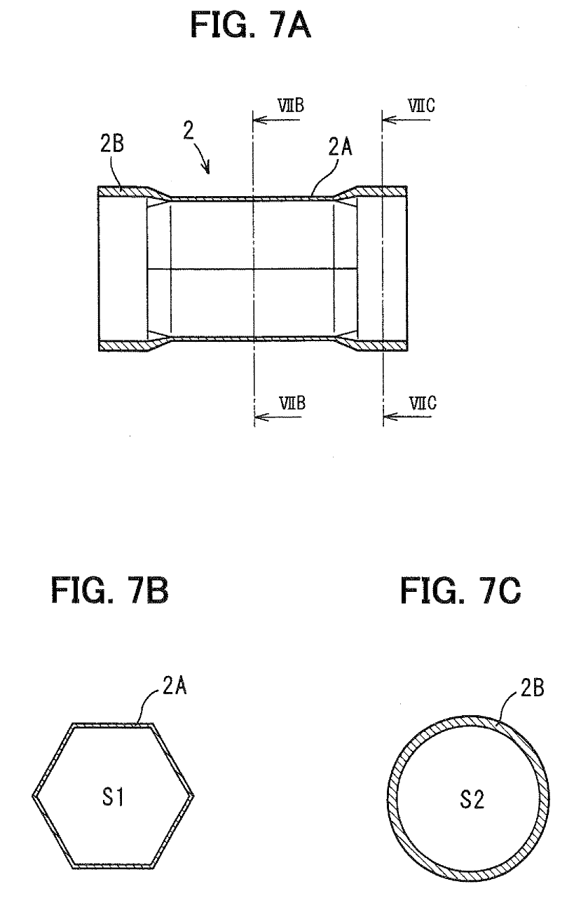

An example of the inner duct 2 having a round cross section is described in the first embodiment. Alternatively, as shown in FIGS. 7A to 7C, for example, an inner duct 2 having a polygonal (e.g., hexagonal) cross-sectional shape may be produced by the production method of the invention. When the inner duct 2 is used in the silencer 1 of the first embodiment, its each planar portion, which constitutes the polygon, serves as a vibrating surface which vibrates by the suction noise, and the vibrating surface has a thickness of 0.5 mm or less, preferably 0.2 mm. A production process of the above inner duct 2 is similar to the first embodiment, and includes a Preform forming process, heating process, stretching process, and blow molding process in this order. By stretching a central parts 20b of a preform 20 in its axial and radial directions in the stretching process, the inner duct 2 having high strength is manufactured. The manufactured inner duct 2 is formed such that a cross-sectional area S1 of its body portion 2A is generally the same as a cross-sectional area S2 of its duct end portion 2B.

### (Modifications)

According to the production method of the inner duct 2 in the first and second embodiments, the inner duct 2 is manufactured from the cylindrical preform 20, both ends of which open, by the stretch blow molding. Alternatively, after carrying out the stretch blow molding on a closed-end preform 20, at least one end side of which is closed, the inner duct 2 may be produced by cutting off the closed-end part. Although the blow molding process is carried out after the stretching process in the first and second embodiments, it is also possible to perform the stretching process and the blow molding process simultaneously. More specifically, the preform 20 may be swollen in its radial direction by blowing high pressure gas into the inside of the preform 20 while extending the preform 20 in its longitudinal direction with the major diameter portions 20a of the preform 20 being held.

In the first and second embodiments, the inner duct 2 is formed such that the cross-sectional area of the constricted central part 20b of the preform 20 after the molding is generally the same as a cross-sectional area of each of both ends (major diameter portions 20a) of the preform 20. Alternatively, the inner duct 2 may be molded such that the cross-sectional area of the central part 20b is larger than a cross-sectional area of each of the major diameter portions 20a. The method for producing the duct according to the invention is not limited to the production of the inner duct 2, which is used for the silencer 1, and may be applied also to a method for producing ducts used for various purposes, such as an air duct and an exhaust duct for air conditioning.

Additional advantages and modifications will readily occur to those skilled in the art. The invention in its broader terms is therefore not limited to the specific details, representative apparatus, and illustrative examples shown and described.

What is claimed is:

1. A method for producing a duct, comprising:
forming a cylindrical preform that opens at both end portions of the preform in a longitudinal direction of the preform and has a central part, which is narrowed with respect to the both end portions, wherein:
the central part has a smaller cross-sectional area than a cross-sectional area of each of the both end portions; and
the preform is formed from a thermoplastic material, which increases in strength when stretched;
heating the preform after the forming of the preform; and
performing stretch blow molding on the preform after the heating of the preform by stretching the preform in an axial direction as well as in a radial direction of the preform, such that the cross-sectional area of the central part becomes one of:
generally the same as the cross-sectional area of each of the both end portions; and
equal to or larger than the cross-sectional area of each of the both end portions, wherein the central part of the preform is narrowed to such an extent that the central part retains predetermined strength after the performing of the stretch blow molding on the preform.

2. The method according to claim 1, wherein the performing of the stretch blow molding on the preform includes:
extending the preform in a longitudinal direction of the preform with the both end portions of the preform being held; and
swelling the preform in the radial direction by blowing high-pressure gas into an inside of the preform after the extending of the preform.

3. The method according to claim 2, further comprising:
forming the central part into a body portion as a result of the extending and swelling of the preform; and
forming the both end portions into both end portions respectively, as a result of the performing of the stretch blow molding, wherein:
the extending of the preform in the longitudinal direction includes extending the central part in a longitudinal direction of the central part;
the swelling of the preform in the radial direction includes swelling the central part in a radial direction of the central part; and
the body portion has a smaller wall thickness than a wall thickness of each of the both end portions.

4. The method according to claim 1, wherein the performing of the stretch blow molding on the preform includes:
extending the preform in a longitudinal direction of the preform with the both end portions of the preform being held; and
swelling the preform in the radial direction by blowing high-pressure gas into an inside of the preform simultaneously with the extending of the preform.

5. The method according to claim 4, further comprising:
forming the central part into a body portion as a result of the extending and swelling of the preform; and
forming the both end portions into both end portions respectively, as a result of the performing of the stretch blow molding, wherein:
the extending of the preform in the longitudinal direction includes extending the central part in a longitudinal direction of the central part;
the swelling of the preform in the radial direction includes swelling the central part in a radial direction of the central part; and
the body portion has a smaller wall thickness than a wall thickness of each of the both end portions.

6. The method according to claim 1, wherein the thermoplastic material, which increases in strength when stretched, is one of polyethylene terephthalate and polyethylenenaphthalate.
